(19) United States
(12) Patent Application Publication
(10) Pub. No.: US 2025/0276613 A1
(43) Pub. Date: Sep. 4, 2025

(54) TRACTION BATTERY PACK CHARGING AND DISCHARGING OPERATION

(71) Applicant: Ford Global Technologies, LLC, Dearborn, MI (US)

(72) Inventors: Matthew Denlinger, Ferndale, MI (US); Brian Joseph Robert, Saint Clair Shores, MI (US); Thomas J. Coupar, Ann Arbor, MI (US); Andrew Robert Drews, Ann Arbor, MI (US)

(21) Appl. No.: 18/594,088

(22) Filed: Mar. 4, 2024

(51) Int. Cl. B60L 58/22; B60L 58/13; B60L 58/16; B60L 58/21

(52) U.S. Cl. CPC B60L 58/22; B60L 58/13; B60L 58/16; B60L 58/21; B60L 2260/20; B60L 2260/52; B60L 2270/20

(57) ABSTRACT

A traction battery pack operating method includes charging a traction battery pack of an electrified vehicle. The charging includes charging a first subpack of battery cells together with a second subpack of battery cells. The method can discharge the first subpack separately from the second subpack. The method can include during the discharging, maintaining at least one switch in an open state to electrically isolate the first subpack from the second subpack.

### TECHNICAL FIELD

This disclosure relates generally to a traction battery pack and, more particularly, to charging and discharging the traction battery pack.

### BACKGROUND

Electrified vehicles differ from conventional motor vehicles because electrified vehicles can be selectively driven by one or more electric machines that are powered by a traction battery pack. The electric machines can propel the electrified vehicles instead of, or in combination with, an internal combustion engine. The traction battery pack is discharged when powering the one or more electric machines and other loads of the electrified vehicle.

### SUMMARY

In some aspects, the techniques described herein relate to a traction battery pack operating method, including: charging a traction battery pack of an electrified vehicle, the charging including charging a first subpack of battery cells together with a second subpack of battery cells; and discharging the first subpack separately from the second subpack.

In some aspects, the techniques described herein relate to a method, wherein the first subpack of battery cells is a first subpack of battery cells having lithium metal anodes, wherein the second subpack of battery cells is a second subpack of battery cells having lithium metal anodes.

In some aspects, the techniques described herein relate to a method, further including, during the discharging, maintaining at least one switch in an open state to electrically isolate the first subpack from the second subpack.

In some aspects, the techniques described herein relate to a method, further including, when discharging the first subpack separately from the second subpack, providing electrical power from the first subpack to a load, and electrically isolating the second subpack from the load.

In some aspects, the techniques described herein relate to a method, further including transitioning at least one switch to electrically isolate the second subpack from the load.

In some aspects, the techniques described herein relate to a method, wherein the load is at least one motor of the electrified vehicle.

In some aspects, the techniques described herein relate to a method, further including switching from discharging the first subpack separately from the second subpack, to discharging the second subpack separately from the first subpack.

In some aspects, the techniques described herein relate to a method, further including pre-charging the second subpack during the switching.

In some aspects, the techniques described herein relate to a method, wherein the discharging is during a drive cycle.

In some aspects, the techniques described herein relate to a method, further including switching based on a state of health in the first subpack, the second subpack, or both.

In some aspects, the techniques described herein relate to a method, further including switching based on a drive mode of the electrified vehicle.

In some aspects, the techniques described herein relate to a method, further including switching based on a range for the electrified vehicle when discharging from the first subpack reaching a threshold range.

In some aspects, the techniques described herein relate to a method, wherein the discharging the first subpack separately from the second subpack includes discharging the first subpack to a load without discharging the second subpack to the load.

In some aspects, the techniques described herein relate to a method, further including dividing the traction battery pack into the first subpack of battery cells, and the second subpack of battery cells, wherein dividing the traction battery pack into the first subpack and the second subpack includes electrically isolating the second subpack from both the first subpack and a load.

In some aspects, the techniques described herein relate to a method, wherein the traction battery pack is an 800 Volt traction battery pack, wherein the first subpack is 400 Volts and the second subpack is 400 Volts.

In some aspects, the techniques described herein relate to a method, further including dividing the traction battery pack into the first subpack of battery cells, and the second subpack of battery cells, wherein the dividing further includes dividing the traction battery pack into at least one third subpack, and the discharging is a discharging of the first subpack without discharging the second subpack or the at least one third subpack.

In some aspects, the techniques described herein relate to a method, wherein the first subpack and the second subpack are both held within a battery enclosure.

In some aspects, the techniques described herein relate to a traction battery assembly, including: a traction battery pack that powers a load; and a switching system that is configured to transition between a charging state, a first discharging state, and a second discharging state, when the switching system is in charging state, a first subpack of battery cells in the traction battery pack and a second subpack of battery cells in the traction battery pack are both configured to be charged, when the switching system is in first discharging state, the first subpack is electrically connected to the load while the second subpack is electrically isolated from the load, when the switching system is in the second discharging state, the second subpack is electrically connected to the load while the first subpack is electrically isolated from the load.

In some aspects, the techniques described herein relate to a traction battery assembly, wherein the switching system electrically isolates the first subpack of battery cells from the second subpack of battery when the switching system is in the first discharging state and when the switching system is in the second discharging state.

In some aspects, the techniques described herein relate to a traction battery assembly, wherein the first subpack of battery cells is a first subpack of battery cells having lithium metal anodes, wherein the second subpack of battery cells is a second subpack of battery cells having lithium metal anodes.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle according to an exemplary aspect of the present disclosure.

FIG. 2 illustrates an expanded view of a traction battery pack from the electrified vehicle of FIG. 1.

FIG. 3 illustrates a flow of an example method of operating the traction battery pack of FIG. 2.

FIG. 4 illustrates a schematic view of the traction battery pack of FIG. 2 when operating in a charging state where a first subpack of the traction battery pack and a second subpack of the traction battery pack are charged together.

FIG. 5 illustrates a schematic view of the traction battery pack of FIG. 2 when operating in a first discharging state where the first subpack is powering a load and the second subpack is isolated from both the load and the first subpack.

FIG. 6 illustrates a schematic view of the traction battery pack of FIG. 2 when operating in a second discharging state where the second subpack is powering a load and the first subpack is isolated from both the load and the second subpack.

### DETAILED DESCRIPTION

A traction battery pack of an electrified vehicle can include battery cells that are charged and discharged. The battery cells can be charged from, for example, an external power source or, if the electrified vehicle is a hybrid electric vehicle, from a generator of the electrified vehicle. The battery cells can be discharged to power one or more traction motors or other loads of the electrified vehicle. Charging and discharging at different rates can prolong a life of some types of battery cells, such as battery cells having lithium metal anodes.

With reference to FIGS. 1 and 2, an electrified vehicle 10, in an exemplary non-limiting embodiment, includes a traction battery pack 14 that powers an electric machine 18. The electrified vehicle 10 further includes wheels 22 driven by the electric machine 18. The traction battery pack 14 can power the electric machine 18, which converts electric power to torque to drive the wheels 22.

The electrified vehicle 10 is an all-electric vehicle. In other examples, the electrified vehicle 10 is a hybrid electric vehicle, which can selectively drive wheels using torque provided by an internal combustion engine instead, or in addition to, an electric machine. Generally, the electrified vehicle 10 could be any type of vehicle having a traction battery pack.

The traction battery pack 14 includes an enclosure 30 that encloses a plurality of battery arrays 34. Each of the battery arrays 34 includes a plurality of individual battery cells 38, which, in this example, have lithium metal anodes. Such battery cells 38 can provide relatively high energy densities and can have their cycle lives extended by discharging at rates significantly higher than the rate at which they are charged. The battery cells with the lithium metal anodes can include battery cells with liquid electrolytes, battery cells with solid electrolytes, or some combination thereof.

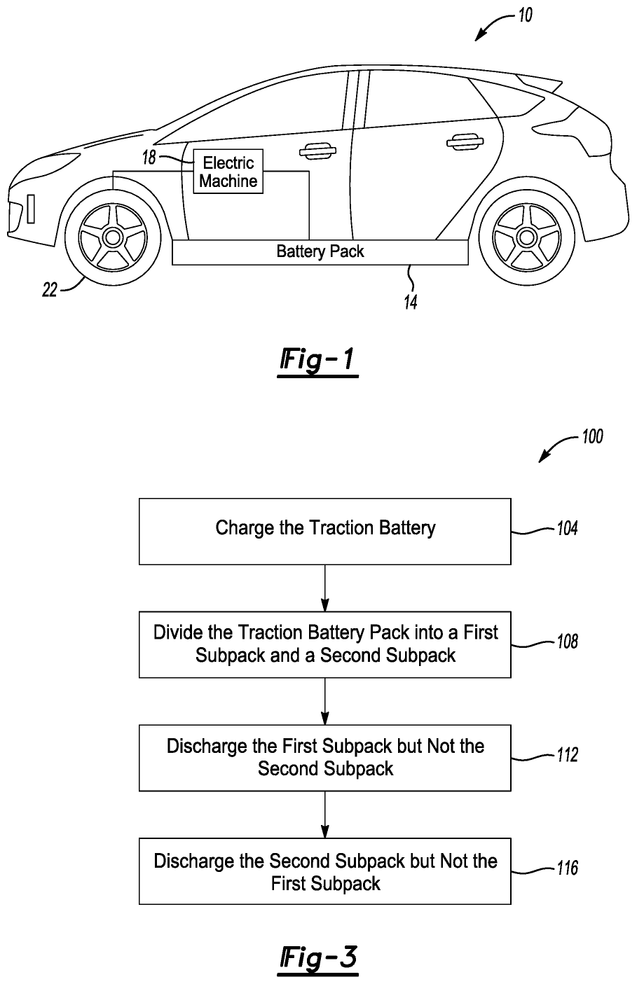

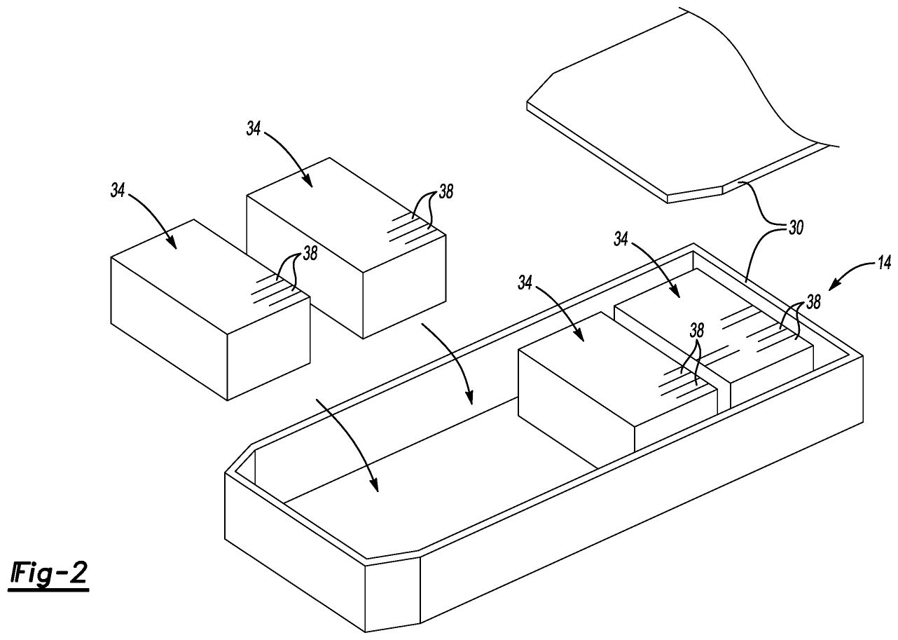

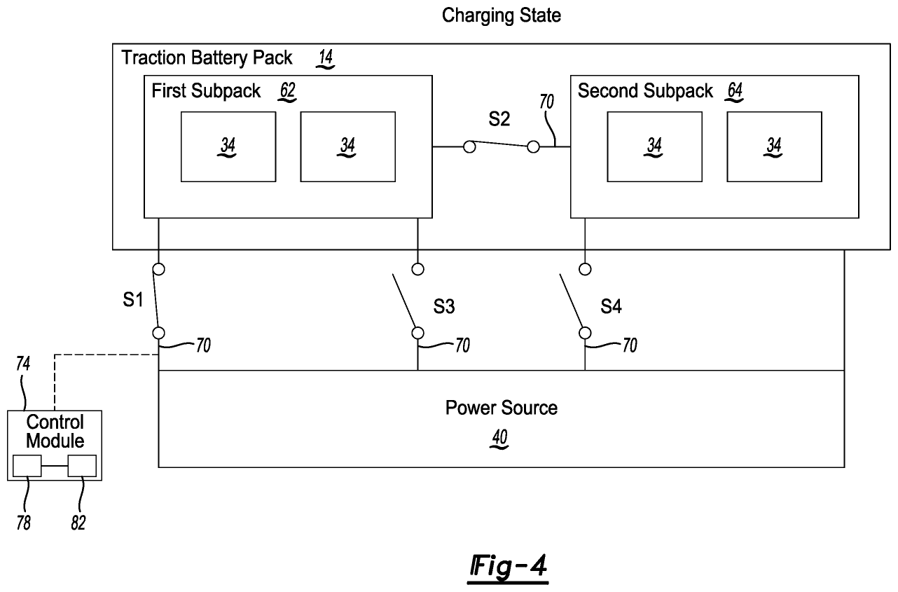

With reference now to FIGS. 3-6 and continuing reference to FIGS. 1 and 2, a method 100 of operating the traction battery pack 14 generally includes a step 104 of charging the traction battery pack 14. The step 104 can include charging the traction battery pack 14 from an power source 40, which can be an external power source, such as a charge station. In another example, the charging is from one or more generators of the electrified vehicle 10.

The charging includes charging a first subpack 62 of battery cells 38 together with a second subpack 64 of battery cells 38. The first subpack 62 and the second subpack 64 are both held within the enclosure 30 in this example.

In this example, the first subpack 62 can include two of the battery arrays 34. The second subpack 64 can include the two remaining battery arrays 34. If the traction battery pack 14 is an 800 Volt pack, the first subpack 62 and the second subpack 64 can then each be 400 Volts. Packs having other voltages could be used in other examples, including 1200 Volt packs.

The charging of the first subpack 62 and the second subpack 64 can occur when the first subpack 62 and the second subpack 64 are connected in parallel or in series. Charging when the first subpack 62 and the second subpack 64 are connected in series as an 800 Volt pack can lower the current required to meet a charging power goal.

In this example, the battery cells 38 of the first subpack 62 and the battery cells 38 of the second subpack 64 have the same chemistries (i.e., both nickel manganese cobalt (NMC), lithium iron phosphate (LFP), or nickel cobalt aluminum (NCA). In other examples, the battery cells 38 and the battery cells 38 of the second subpack 64 have different chemistries. The chemistries need not be the same, but the voltage scale between the first subpack 62 and the second subpack 64 is typically similar.

A switching system 70 is transitioned to electrically connect together the first subpack 62 and the second subpack 64 during charging. The switching system 70, in this example, includes switches S1, S2, S3, and S4. Switches S1 and S2 are transitioned to a closed state during charging. Switches S3 and S4 are transitioned to an open state.

In an embodiment, a control module 74, such as a vehicle controller, executes the method 100 by controlling the transitions of the switching system 70. However, other configurations and types of control are contemplated within the scope of this disclosure. Although shown schematically as a single control module 74, a plurality of control modules could be operably linked and configured to function together for facilitating various monitoring and control strategies associated with the traction battery pack 14 with the first subpack 62 and the second subpack 64.

The control module 46 may include a processor 78 and non-transitory memory 82 for executing various control strategies and modes associated with the method 100. The processor 78 can be a custom made or commercially available processor, a central processing unit (CPU), or generally any device for executing software instructions. The memory 82 can include a combination of volatile memory elements and nonvolatile memory elements.

The processor 78 can be operably coupled to the memory 82 and may be configured to execute one or more programs stored in the memory 82 of the control module 74 based on the various inputs received from other devices, such the switches S1, S2, S3, S4, and various sensors within and outside of the traction battery pack 14.

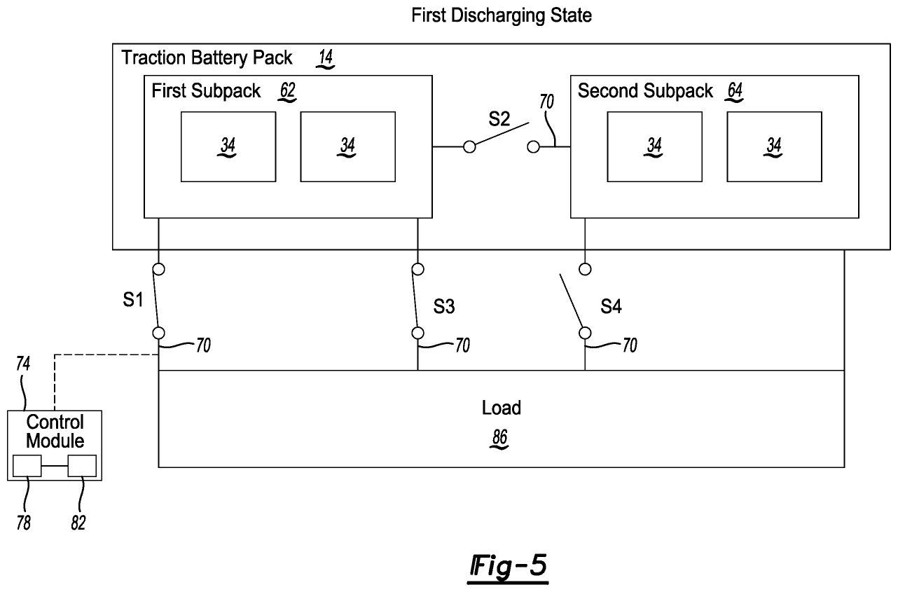

At a step 108, after the charging, the method 100 divides the traction battery pack 14 into the first subpack 62 of battery cells 38 and a second subpack 64 of battery cells 38. The example method 100, as schematically shown in FIG. 5, transitions the switching system 70 to divide the traction battery pack 14 in this way. In particular, switches S1 and S3 are transitioned to a closed state, and switches S2 and S4 are transitioned to an open state. The switches S1, S2, S3, S4 are maintained in these states when discharging from the first subpack 62.

This configuration for the switching system 70 effectively electrically isolates the first subpack 62 from the second subpack 64 and from a load 86. This configuration for the switching system 70 electrically couples the first subpack 62 to the load 86. The load 86 can be the electric machine 18, other high-voltage loads of the electrified vehicle 10, or both. At a step 112, the method 100 then discharges the first subpack 62, but not the second subpack 64.

When configured as shown in FIG. 5, the switching system 70 is considered in a first discharge state. In the first discharge state, the first subpack 62 discharges by providing power to the load 86. The second subpack 64 is electrically isolated from the load and from the first subpack 62. The second subpack 64 is thus not discharging, and the first subpack 62 is discharging separately from the second subpack.

The method 100, at a step 116, stops discharging from the first subpack 62 and starts discharging from the second subpack 64. This can occur in response to a triggering event, such as a state of charge within the first subpack 62 dropping to a threshold state of charge, say ten percent,

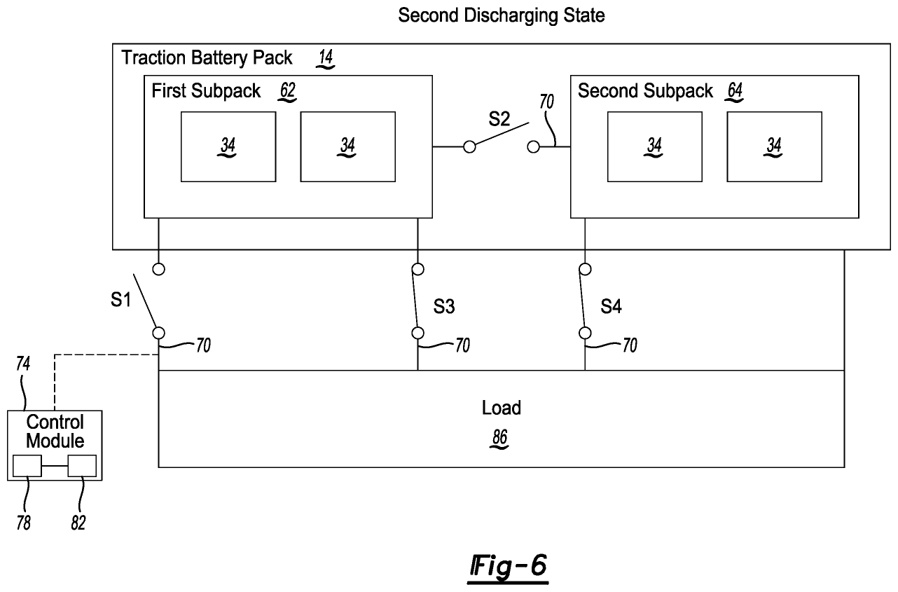

The switching system 70 is reconfigured to make this change. FIG. 6 schematically shows the switching system 70 transitioned so that the second subpack 64 is discharging instead of the first subpack 62. To make this change, the switches S1 and S2 are transitioned or maintained in an open state, and switches S3 and S4 are transitioned or maintained in a closed state.

In some examples, the method 100 includes pre-charging the second subpack 64 to inhibit electrical issues associated with in-rush current when changing from discharging from the first subpack 62 to discharging from the second subpack. The pre-charging may involve a circuit with power resistors to limit in-rush, or a DC/DC converter employed to compensate for imbalances between the first subpack 62 and the second subpack 64.

The step 116 can take place when the electrified vehicle 10 is moving during a drive cycle. The triggering event prompting the method 100 to begin discharging from the second subpack 64 instead of the first subpack 62 can, in some examples, be based on a drive mode. For example, discharging from the first subpack 62 can occur when the electrified vehicle 10 is operating in a front-wheel drive mode, and discharging from the second subpack 64 can occur when the electrified vehicle 10 is operating in an all-wheel drive mode.

In some examples, the first subpack 62 is designated to power one or more motors of the electrified vehicle 10, and the second subpack 64 is designated for powered one or more other motors of the electrified vehicle 10.

Another example triggering event could include a state of health of the first subpack 62, the second subpack 64, or both. Another triggering event could include a thermal energy level within the first subpack 62, the second subpack 64, or both. Switching from discharging from the first subpack 62 to discharging from the second subpack 64 can provide time for thermal energy to dissipate from the first subpack 62.

Yet another example triggering event could be a range of the electrified vehicle 10 when powered by the first subpack 62. The switch at the step 116 can occur, for example, when the electrified vehicle 10 has reaches a threshold range for driving when powered by the first subpack 62. The switch from discharging from the first subpack 62 to the second subpack 64 could occur when a range for the electrified vehicle 10 when powered by the first subpack 62 falls below fifty miles, for example.

The switch at the step 116 could instead or additionally occur based on a desired state of charge for the first subpack 62 and the second subpack 64 when reaching a destination. For example, if reaching a destination with a substantially equal state of charge in both the first subpack 62 and the second subpack 64 is desired, the switch could occur midway through a journey to the destination. This can help the vehicle 10 to arrive at the destination with both the first subpack 62 and the second subpack 64 at substantially the same temperature, state of charge, etc.

As can be appreciated, the method 100 can include switching back to a discharging from the first subpack 62 if desired. Further, the method 100 can include discharging concurrently from both the first subpack 62 and the second subpack 64 if, for example, power demands are particularly high. This could be in response to the electrified vehicle 10 climbing a hill, for example.

Although described in connection with dividing the traction battery pack 14 into the first subpack 62 and the second subpack 64, it should be understood that other divisions are possible. For example, the traction battery pack 14 could additionally be divided into at least one third subpack. That is, although described as being divided into two subpacks, the traction battery pack 14 could be divided into more than two subpacks.

In some examples, the control module 74 adjusts cooling of the traction battery pack 14 in response to whether the first subpack 62 or the second subpack 64 is discharging. More coolant could be directed to a thermal exchange plate associated with the first subpack 62 when the first subpack 62 is discharging, for example. In some examples, a cooling system can be sized to cool only the first subpack 62 or the second subpack 64. Cooling would be, as can be appreciated, directed toward the first subpack 62 when discharging, and then change to the second subpack 64 when discharging.

Features of the disclosed examples include a traction battery pack dividable into discrete subpacks that are dynamically controlled to combine them during vehicle charge, but separate them during discharge, operating the vehicle from one sub-pack independently during drive. Additional subpacks could be included to, for example, optimize a charge/discharge ratio or to provide compatibility with future voltage standards. Dividing the traction battery pack in this way can lengthen cycle life, particularly for lithium metal cells.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack operating method, comprising:
charging a traction battery pack of an electrified vehicle, the charging including charging a first subpack of battery cells together with a second subpack of battery cells; and
discharging the first subpack separately from the second subpack.

2. The method of claim 1, wherein the first subpack of battery cells is a first subpack of battery cells having lithium metal anodes, wherein the second subpack of battery cells is a second subpack of battery cells having lithium metal anodes.

3. The method of claim 1, further comprising, during the discharging, maintaining at least one switch in an open state to electrically isolate the first subpack from the second subpack.

4. The method of claim 1, further comprising, when discharging the first subpack separately from the second subpack, providing electrical power from the first subpack to a load, and electrically isolating the second subpack from the load.

5. The method of claim 4, further comprising transitioning at least one switch to electrically isolate the second subpack from the load.

6. The method of claim 4, wherein the load is at least one motor of the electrified vehicle.

7. The method of claim 1, further comprising switching from discharging the first subpack separately from the second subpack, to discharging the second subpack separately from the first subpack.

8. The method of claim 7, further comprising pre-charging the second subpack during the switching.

9. The method of claim 7, wherein the discharging is during a drive cycle.

10. The method of claim 7, further comprising switching based on a state of health in the first subpack, the second subpack, or both.

11. The method of claim 7, further comprising switching based on a drive mode of the electrified vehicle.

12. The method of claim 7, further comprising switching based on a range for the electrified vehicle when discharging from the first subpack reaching a threshold range.

13. The method of claim 1, wherein the discharging the first subpack separately from the second subpack comprises discharging the first subpack to a load without discharging the second subpack to the load.

14. The method of claim 1, further comprising dividing the traction battery pack into the first subpack of battery cells, and the second subpack of battery cells, wherein dividing the traction battery pack into the first subpack and the second subpack comprises electrically isolating the second subpack from both the first subpack and a load.

15. The method of claim 1, wherein the traction battery pack is an 800 Volt traction battery pack, wherein the first subpack is 400 Volts and the second subpack is 400 Volts.

16. The method of claim 1, further comprising dividing the traction battery pack into the first subpack of battery cells, and the second subpack of battery cells, wherein the dividing further comprises dividing the traction battery pack into at least one third subpack, and the discharging is a discharging of the first subpack without discharging the second subpack or the at least one third subpack.

17. The method of claim 1, wherein the first subpack and the second subpack are both held within a battery enclosure.

18. A traction battery assembly, comprising:
a traction battery pack that powers a load; and
a switching system that is configured to transition between a charging state, a first discharging state, and a second discharging state,
when the switching system is in charging state, a first subpack of battery cells in the traction battery pack and a second subpack of battery cells in the traction battery pack are both configured to be charged,
when the switching system is in first discharging state, the first subpack is electrically connected to the load while the second subpack is electrically isolated from the load,
when the switching system is in the second discharging state, the second subpack is electrically connected to the load while the first subpack is electrically isolated from the load.

19. The traction battery assembly of claim 18, wherein the switching system electrically isolates the first subpack of battery cells from the second subpack of battery when the switching system is in the first discharging state and when the switching system is in the second discharging state.

20. The traction battery assembly of claim 18, wherein the first subpack of battery cells is a first subpack of battery cells having lithium metal anodes, wherein the second subpack of battery cells is a second subpack of battery cells having lithium metal anodes.
